(19) United States
(12) Patent Application Publication
(10) Pub. No.: US 2003/0195850 A1
(43) Pub. Date: Oct. 16, 2003

(54) Teller one

(76) Inventor: Bruce P. Stallworth, Inglewood, CA (US)

Correspondence Address: Mr. Bruce P. Stallworth, 11139 So. Van Ness, Inglewood, CA, 90303, US

(21) Appl. No.: 10/120,855

(22) Filed: Apr. 12, 2002

(51) Int. Cl. G06F 17/60

(52) U.S. Cl. 705/43

(57) ABSTRACT

A security system for Automatic Teller Machines (ATM), wherein the system activates an emergency sequence when the user enters one (1) or two (2) additional numbers beyond the assigned Personal Identification Number (PIN) for that card. If one additional number is entered, the emergency sequence activates a voice recorder and remote camera, but if two (2) additional numbers are entered, then in addition to the voice recorder and remote camera, the system notifies authorities and a time delay sequence is activated to allow authorities time to be dispatched to the location. Upon completion of the time delay sequence, the ATM completes the transaction as normal.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention involves the use of automatic teller machines (ATM) and the security measures that employed when using ATM Cards.

When customers go to automatic teller machines to conduct banking business, they insert their ATM Card, and the system prompts them to enter their personal identification number (PIN). If the correct PIN is entered, the system allows the user to conduct banking business with the account associated with the card.

However, if the incorrect PIN is entered, the user is allowed to re-enter the PIN a second time. If after the third incorrect entry of the PIN, the card may be blocked, which prevents access to the account information.

Over the years, a new trend has developed wherein thieves pray upon bank customers by either using force to require them to withdraw money from their account, or by stealing the users card and forcing them to disclose the PIN. In order to decrease these type of situations, several applications have been put forth to try to address this problem.

Current systems in place, such as those found in U.S. Pat. Nos. 5,103,079; 5,095,196; 5,029,290; 4,801,787; 4,798,941; 4,650,980; 4,359,630; and 4,304,990 do not have a system in which the user can put authorities on notice that the transaction is being conducted under the threat of force or fear.

U.S. Pat. No. 5,354,974 sought to remedy this situation by implementation of an “emergency” PIN that could be entered if the user was forced to complete the transaction. This system addresses the problem directly, but requires the user to remember two separate and distinct PIN's. In today's highly technologically advance society, wherein consumers have PIN's for just about everything, including cell phones, pagers, and computers, the thought of trying to remember a separate PIN can be burdensome, especially for older consumers.

### SUMMARY OF THE INVENTION

This invention seeks to improve upon the current systems lack of a security device and the burdensome task of remembering a second “emergency” PIN as found in U.S. Pat. No. 5,354,974. The basic premise of the invention involves the use of the PIN that is assigned to each user, but implements a system wherein the user types in any two more numbers.

When a person puts in their PIN number in any ATM, the number is verified against the card number and a transaction takes place. If the person is forced to make a transaction due to a gun, knife, or other threat, the person usually is not in a position to push the 911 Emergency buttons, which are present on some ATM machines.

The security system feature of this invention is activated when a user inputs types in their correct security code, but then types in any two more numbers. If the person only types in one (1) more number, the system goes on alert and starts the additional security camera (one additional camera on the roof to provide area coverage) and a voice recorder (located at the ATM area). When the person types in the second (2) number a call is placed to the local security agency and security forces are dispatched to the machine.

In addition, the machine displays a typical “WAIT” message, such as “PLEASE BE PATIENT—YOUR REQUEST IS BEING PROCESSED”. This message is displayed for at least three (3) minutes. The delay in processing allows time for security to arrive and prevents the person from getting any cash from the account during this period. At then end of three (3) minutes, the cash is dispensed.

The PIN number of the card owner is not affected by the addition of the security feature. The system only activates when the additional one or two numbers are imputed triggering the added security response.

The benefits of this system is that the user who is forced to withdraw money from their account will be able to act as they normally would without alerting the thief that they have notified the police. Additionally, if the card owner is required to disclose their PIN to a thief under duress, all they have to do is to add the two (2) additional numbers on the end of their regular PIN and the thief automatically will notify authorities while using the card.

### BRIEF DESCRIPTION OF THE SEVERAL VIEWS OF THE DRAWING

FIG. 1: A flow chart of this invention showing the different steps that the automatic teller machine will implement based on the PIN being entered correctly and the corresponding scenario that occurs if either an incorrect PIN is entered or additional numbers entered after the correct PIN number.

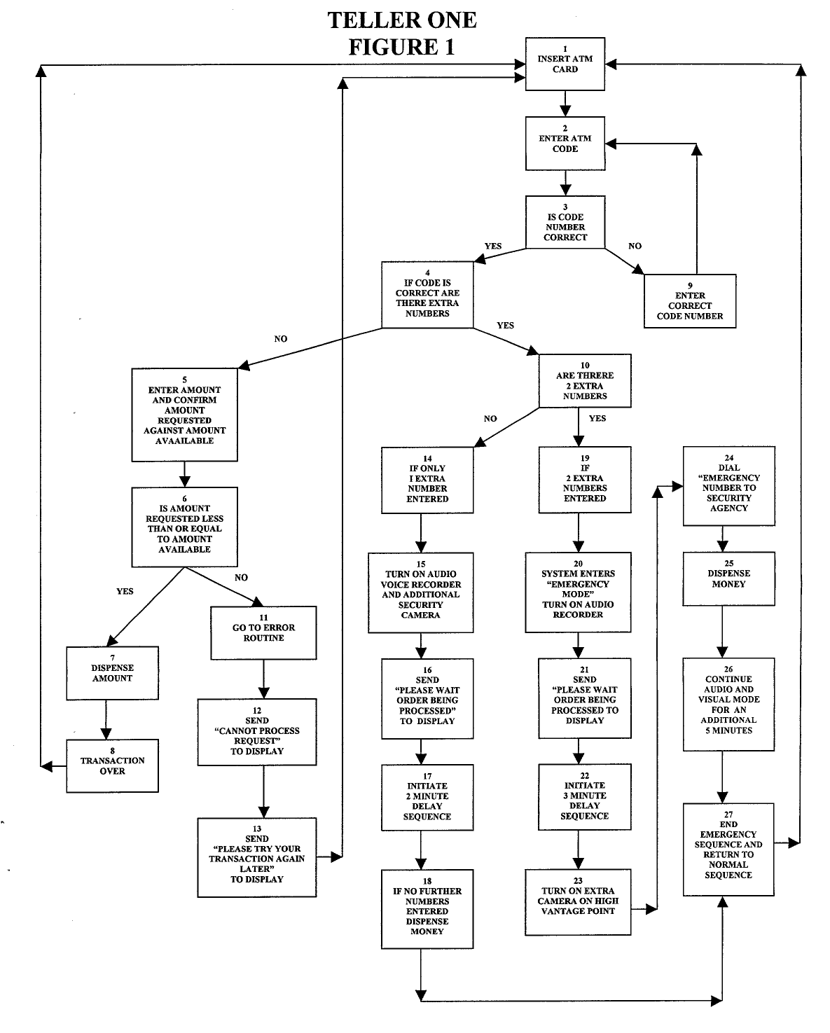

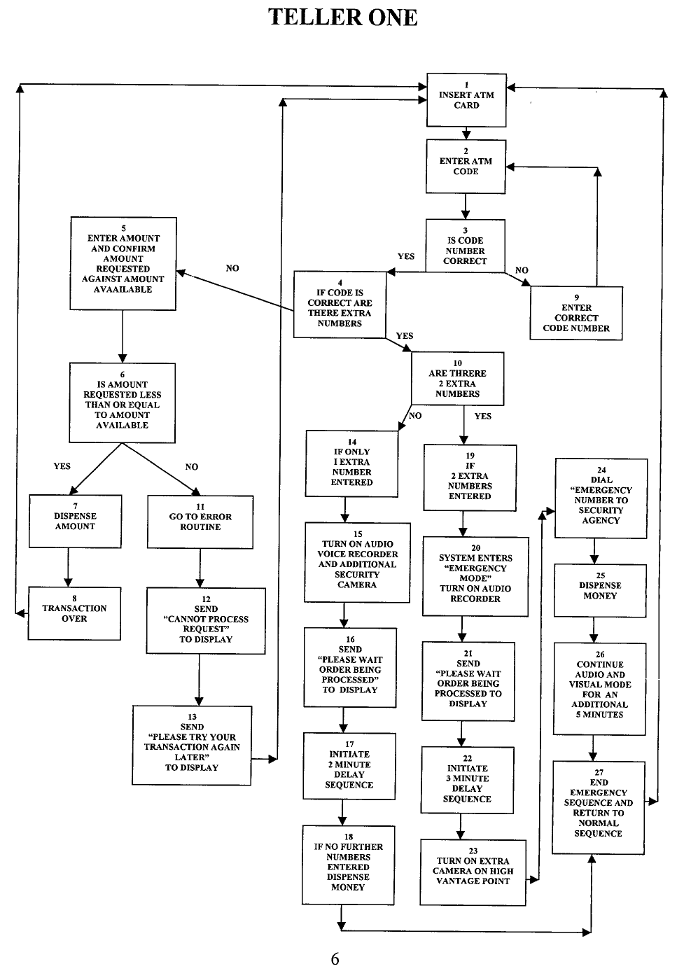

### DETAILED DESCRIPTION OF THE INVENTION

When a user goes to an ATM machine to withdraw cash, they insert the ATM Card 1, and then they are prompted to enter the ATM Code 2. The system processes the PIN to determine if the correct number was entered 3. If the incorrect PIN is entered 9, the system reverts back to 2 prompting the user to reenter their PIN. If the correct PIN was entered, the system then checks to see if extra numbers were entered 4. If no extra numbers were entered, then the system prompts the user to enter the amount of money requested and this amount is verified against the amount available 5. If the amount requested is greater than amount available, then the system produces an error message 11, which reads, “Cannot Process Request” 12, then a message “Please Try Your Transaction Again Later” 13 and the card is ejected and the system resets to “Please Insert Your Card” 1.

When the user enters an amount that is less than or equal to the amount available in the account, then the system dispenses the amount requested 7, and the transaction is over 8 and the system then resets it self to “Please Insert Your Card” 1.

Referring back to step 4, wherein the system determines that the PIN is correct, then it seeks to detect if extra numbers were entered, the system first looks to see if two (2) extra number were entered 10. If only one (1) extra number is entered 14, then the automatic voice recorder and additional security camera is activated 15, and the message “Please Wait Order is being Processed” is displayed 16. At this time, a two (2) minute delay sequence is initiated 17, and then upon completion of the two minutes, the money is dispensed and emergency sequence returns to normal status 27, wherein the system resets itself to “Please Insert Your Card” 1.

If on the other hand the system at step 10 determines that two extra numbers were entered 19, then the system goes in emergency mode wherein the audio recorder is activated 20, the message “Please Wait Order Being Processed” is displayed 21, and the system initiates a three (3) minute delay sequence 22, and the extra camera is activated 23. At the same time, the computer dials the emergency number to security agency 24, and the user is detained for the entire three minutes while authorities arrive to the location. At the end of the three minute period, the money is dispensed 25, but audio and visual surveillance continues for an additional five (5) minutes 26. After the five minutes have elapsed, the emergency sequence ends, and the machine returns to normal sequence 27, and then the system resets to “Please Insert Your Card” 1.

Although the above description accurately embodies the basic premise of the invention, it is understood that certain modifications have to be made to allow the system to effectively provide the necessary security that is desired by this invention. However, any changes and or modifications that may be made would still not change the underlying scope and goals of this particular invention.

What I claim is:

1. A security system for Automatic Teller Machines, wherein a user goes to withdraw cash from an ATM machine, and inserts their ATM card, the system prompts them to enter their PIN. At this time the system first checks if the PIN is valid, then it determines whether two (2) additional numbers have been entered. If only one (1) additional number has been entered, then the system begins the initial phase of the emergency sequence, wherein the voice recorder is activated, and a remote camera is activated. The transaction proceeds as normal on a time delay for two (2) minutes until completed, and then the cash is dispensed. If on the other hand, the system detects that two (2) additional numbers have been entered, then the emergency sequence begins with the voice activated recorder and the remote camera recording, and the additional emergency notification of security personnel with a five (5) minute time delay. This delay allows time for authorities to be dispatched to the location. At the end of the time delay, the transaction proceeds as normal and cash is dispensed.
